(19) United States
(12) Patent Application Publication
(10) Pub. No.: US 2025/0328793 A1
(43) Pub. Date: Oct. 23, 2025

(54) Machine Learning System Using Quantum Computing

(71) Applicant: HSBC Technology & Services (USA) Inc.

(72) Inventors: Mekena METCALF, Dixon, CA (US); Philip INTALLURA, Wallington, Surrey (GB); Jorja J. KIRK, London (GB)

(73) Assignee: HSBC Technology & Services (USA) Inc., (US)

(21) Appl. No.: 18/593,494

(22) Filed: Mar. 1, 2024

Related U.S. Application Data
(60) Provisional application No. 63/449,128, filed on Mar. 1, 2023.

(51) Int. Cl. G06N 10/20; G06N 10/60

(52) U.S. Cl. CPC G06N 10/20; G06N 10/60

(57) ABSTRACT

Methods and systems for training and using a binary classifier implemented using quantum computing techniques are disclosed. The described approach involves deriving, from an input data set, a plurality of training samples, each training sample comprising a data vector having a plurality of features and a class label. Each data vector is processed using a quantum classification process including: encoding the data vector as an Ising Hamiltonian; implementing the Ising Hamiltonian on a set of real or virtual qubits of a quantum processing unit or an emulation thereof to form a quantum system representing the data vector; executing operations on the (emulation of the) quantum processing unit to prepare the ground state of the quantum system; determining one or more properties of the ground state; and identifying one of a set of possible ground states corresponding to the data vector based on the one or more properties. The system then determines, based on the identified ground states and class labels for the training samples, a mapping that maps ground states to class labels. The mapping is stored and used for classifying further data samples.

### CROSS-REFERENCE TO RELATED APPLICATIONS

This application claims priority to U.S. Ser. No. 63/449,128, entitled MACHINE LEARNING SYSTEM USING QUANTUM COMPUTING, filed Mar. 1, 2023, all of which is incorporated herein by reference in its entirety.

### FIELD OF THE INVENTION

The present application relates to implementation of machine learning systems, in particular binary classifiers, using quantum computing methods including quantum processing units or emulations of quantum processing units.

### BACKGROUND OF THE INVENTION

Although there has recently been increasing interest in using quantum computing to implement machine learning systems, the limited processing capacity of current and near-term quantum computers presents significant challenges. In particular, meaningful encodings of classical data on quantum processing hardware have proved difficult. Encoding data using native control-Z operations and virtual Z rotations is a hardware efficient mechanism to express the classical problem on a quantum computer, however, the exponential quantum state space causes model overfitting.

### SUMMARY OF THE INVENTION

Embodiments of the invention seek to resolve the above problems by projecting the encoded model into the ground state by extracting energy from the quantum system with non-unitary measurements on an auxiliary system. These non-unitary measurements cool the quantum model into the ground state. Information is extracted from the quantum computer as observables that feed a predictive model. Embodiments in which the quantum computation is performed in an emulation of a quantum computing environment.

Aspects of the invention are set out in the independent claims. Certain preferred features are set out in the dependent claims.

Disclosed herein is a method comprising:
deriving, from an input data set, a plurality of training samples, each training sample comprising a data vector having a plurality of features and a class label;
processing each data vector using a quantum classification process including:
   encoding the data vector on a real or virtual set of qubits of a quantum computation environment, the quantum computation environment being a quantum processing unit having real qubits or an emulation of a quantum processing unit having virtual qubits, to form a quantum system representing the data vector;
   executing one or more operations in the quantum computation environment to prepare the ground state of the quantum system;
   determining one or more properties of the ground state; and
   identifying one of a set of possible ground states corresponding to the data vector based on the one or more properties;
the method further comprising determining, based on the identified ground states and class labels for the training samples, a mapping that maps ground states to class labels; and
storing the mapping for use in classifying further data samples.

Encoding the data vector preferably comprises: encoding the data vector as a Hamiltonian, preferably an Ising Hamiltonian; and implementing the (Ising) Hamiltonian on the set of qubits.

The one or more properties preferably comprise one or both of: a correlation property; and a parity property. The correlation property preferably indicates pairwise spin correlation between real or virtual qubits of the quantum system and/or comprises a value indicating one of: a lattice with ferromagnetic order; and a lattice with antiferromagnetic order. The parity property preferably distinguishes first and second antiferromagnetic states with opposite spin configurations.

Determining the properties may include obtaining one or more measurements of the ground state indicative of the one or more properties, e.g. measuring one or more characteristics of the ground state, and determining (e.g. calculating) one or more of the properties based on the measurement(s).

Preferably, identifying a ground state comprises associating a first ground state with a parity value indicative of the first antiferromagnetic state, and a second ground state with a parity value indicative of the second antiferromagnetic state. The first and second ground states may further be identified based on the correlation property, preferably such that the first and second ground states have a correlation value equal to −1. Ground states with a correlation other than −1 may be considered associated with a residual state space.

Preferably, determining a classification mapping comprises determining the mapping for each of a plurality of labels, preferably for two labels of a binary classification scheme.

Determining the classification mapping may comprise computing a probability distribution indicating probabilities for different combinations of ground states observed for given data vectors and the corresponding class labels associated with those data vectors. The probability distribution preferably specifies, for each class label, probabilities of observing a plurality of respective ground states for data vectors associated with the class label. In particular, the probability distribution preferably specifies probabilities of observing two distinct antiferromagnetic ground states for each of two binary class labels. The method may comprise determining, for each class label, the number of occurrences of each ground state for data vectors having the class label that was identified by the quantum classification process; and computing the probabilities based on the determined occurrences.

Determining or using the mapping preferably comprises mapping each of a set of observable ground states to a class label having the highest probability for that ground state according to the probability distribution.

Preferably, the method further comprises: receiving a further data sample; deriving a data vector from the further data sample; processing the data vector using the quantum classification process to identify a ground state for the data vector; determining a class label for the data vector based on the identified ground state using the determined mapping between ground states and class labels; and outputting the class label as a classification of the further data sample. Determining a class label using the mapping may comprise selecting the class label having the highest probability for the identified ground state according to the mapping.

Preferably, the encoding step comprises: computing coefficients of the (Ising) Hamiltonian (or other encoding); and storing a data representation of the Hamiltonian (or other encoding) comprising the coefficients, the data representation optionally comprising a graph or matrix representation.

Processing a given data vector using the quantum classification process preferably comprises: generating a first quantum circuit for implementing the encoding of the data vector (such as the Ising Hamiltonian) in the quantum computation environment; combining the first quantum circuit with a second quantum circuit configured to prepare the ground state of the quantum system; and transmitting the combined quantum circuit to a controller associated with the quantum computation environment. Preferably, the combining step further combines the first and second quantum circuits with a third quantum circuit for obtaining or measuring the one or more ground state properties or characteristics indicative of the one or more ground state properties.

The third quantum circuit is preferably configured to obtain one or more measurements indicative of one or both of: the spin correlation, and the parity of the ground state.

The method preferably comprises controlling, by the controller, the quantum computation environment to perform the quantum classification process in accordance with the quantum circuit(s). For example, the quantum controller may transform the circuit(s) into control signals implementing the gate operations of the circuit(s).

Preferably, the method comprises, using the controller, obtaining one or more measurement(s) indicative of the one or more ground state properties from the quantum computation environment and storing the measurements and/or ground state properties. The ground state properties may be derived or computed from the measurements as needed.

Preferably, measurements indicative of the one or more ground state properties are measured using one or more real or virtual auxiliary qubits and/or are measured non-destructively.

In certain embodiments, one or more of the steps of deriving training samples, encoding data vectors, identifying a ground state, and/or determining a mapping, may be performed by a machine learning system comprising one or more classical computing devices. Implementation of the encoding (e.g. Ising Hamiltonian) on a set of real or virtual qubits, preparation of the ground state and/or obtaining one or more measurement(s) indicative of one or more ground state properties may be performed in the quantum computation environment.

Preferably, deriving a plurality of training samples from an input data set comprises selecting a subset, preferably a balanced subset, of training samples from the input data set (e.g. with fewer training samples than there are samples in the input set i.e. a strict subset).

Deriving a plurality of training samples may comprise processing input samples of the input data set to perform dimensionality reduction, thereby reducing a number of features in the training samples, preferably comprising performing principal component analysis.

Deriving a plurality of training samples may further comprise scaling features of the training samples.

Optionally where the quantum computation environment is an emulation of a quantum processing unit having virtual qubits, emulating a quantum processing unit includes: constructing, in the quantum computation environment, a Hamiltonian in the form of a matrix product operator for each input data vector from the input data set, the matrix product operator having dimension at least as large as the size of the data vector;
generating a random matrix product state;
iteratively determining a form of the matrix product state which is an eigenvector of the matrix product operator, having the lowest eigenvalue; and wherein
determining one or more properties of the ground state includes performing expectation value measurements on the matrix product state in the form of the matrix product state which is an eigenvector having the lowest eigenvalue.

There is also disclosed herein a method comprising:
receiving a data sample comprising a data vector having a plurality of features;
processing the data vector using a quantum classification process including:
   encoding the data vector on a set of real or virtual qubits of a quantum computation environment, the quantum computation environment being a processing unit having real qubits or an emulation of a quantum processing unit having virtual qubits, to form a quantum system representing the data vector (e.g. by encoding as an Ising Hamiltonian);
   executing operations in the quantum computation environment to prepare the ground state of the quantum system;
   determining one or more properties of the ground state; and
   identifying one of a set of possible ground states corresponding to the data vector based on the one or more properties;
the method further comprising:
   accessing a mapping that maps ground states to class labels;
   associating a class label with the data sample based on the identified ground state and the mapping; and
   outputting the class label as a classification of the further data sample.

The method in this example may include any of the features of a method as set out above.

In the above examples, instead of using an Ising (or other) Hamiltonian, the method may represent the data vector on a quantum system of qubits of the quantum computation environment in another form.

The disclosure also encompasses a system having means, optionally comprising a computer device having a processor with associated memory and being coupled to a quantum computation environment, for performing any method as set out herein.

Also disclosed is a hybrid computer system for classifying data samples, comprising:
a quantum computation environment;
a controller adapted to implement operations in the quantum computation environment; and
a computer system configured to:
   process a plurality of training samples to obtain a set of data vectors;
   for each data vector, generate a quantum circuit adapted to:
      represent the data vector on a quantum system of real or virtual qubits of the quantum computation environment;
      prepare a ground state of the quantum system; and
      measure one or more properties of the ground state;
   transmit the quantum circuit to the controller for execution on the quantum computation environment;
   receive measurement data representative of the one or more measured ground state properties from the controller; and
   identify one of a set of possible ground states corresponding to the data vector based on the measurement data;
the computer system further configured to:
   determine, based on the identified ground states and class labels associated with the training samples, a mapping that maps ground states to class labels; and
   use the mapping to classify further data samples. Here a hybrid system may refer to a classical computer in conjunction with a quantum computer or a classical computer in conjunction with an emulation of a quantum computer. Here, the quantum circuit may be represented as a series of gates implementable on a quantum computer, or in matrix (or tensor) form representing a set of manipulations of quantum states equivalent to such a circuit.

The system in this example may be configured to perform any method as set out above. The disclosure also independently provides a method of carrying out the operations performed by the system as defined in this example.

The disclosure further encompasses a computer program, computer program product or non-transient computer readable medium comprising software code adapted, when executed by a data processing system connected to quantum computation environment, to configure the data processing system and associated quantum computation environment to perform any method as set out herein.

Features of one aspect or example may be applied to other aspects or examples, in any combination. For example, method features may be applied to system or computer program aspects or examples (and vice versa).

### BRIEF DESCRIPTION OF THE FIGURES

Certain embodiments of the invention will now be described by way of example only, in relation to the Figures, wherein:

FIG. 1A illustrates machine learning system utilizing quantum computing;

FIG. 1B illustrates a machine learning system using an emulation of a quantum computing environment;

FIG. 2 illustrates a machine learning process implementing a hybrid classical/quantum binary classifier;

FIG. 3A illustrates a method used by the hybrid classifier for encoding data by mapping data onto a quantum spin model in the form of an Ising Hamiltonian and algorithmically extracting ground state information on a quantum computer;

FIG. 3B illustrates a method used by the hybrid classifier for encoding data by mapping data onto a quantum spin model in the form of an Ising Hamiltonian and algorithmically extracting ground state information on an emulation of a quantum computer;

FIG. 3C illustrates a method for applying the hybrid classifier to classify unseen samples;

FIG. 4 illustrates a quantum circuit for implementing the Ising Hamiltonian on a quantum computer;

FIG. 5 illustrates a quantum circuit for preparing the ground state;

FIGS. 6A-6B illustrate quantum circuits for measuring parity and correlation of the ground state wave function;

FIG. 7 illustrates a computer device for implementing the machine learning system; and

FIGS. 8-12 illustrate evaluation results.

### DETAILED DESCRIPTION

Embodiments of the invention provide a quantum machine learning technique which provides an interpretable means to classify datasets based on quantum physics. The described approach involves mapping classical data with known features to real or virtual qubits using an Ising Hamiltonian. This compilation to the Ising Hamiltonian is done using a classical computer, and the Ising Hamiltonian is mapped by classical means onto a quantum circuit or an emulation of a quantum information. Quantum resources (actual or emulated) are used to obtain the ground state solution to the Ising Hamiltonian using ground state preparation techniques. Once the ground state is prepared, the measurement results are fed back to the classical computer to be classified. In general this document refers to a quantum computation environment to refer to either an actual quantum computer (also referred to as a quantum processing unit or a quantum computing unit), or to an emulation of a quantum computer. An actual quantum computer is referred to as having real qubits and real circuits, gates, etc., i.e. physical instantiations of quantum objects and gates which are able to store and manipulate quantum information in a controlled manner. Accordingly, an emulation of a quantum computer is referred to as having virtual qubits, i.e. representations of qubits provided in a classical (binary) computing environment. In such cases, the gates and circuits are represented by matrices which perform mathematical operations in emulated quantum information equivalent to their real gate counterparts.

The lowest energy eigenstate is extracted from the quantum Hamiltonian and serves as an indicator of the data class. Different data classes exhibit different ground states. In the case of binary classification, a level crossing serves as the hyperplane to separate the two classes. The approach provides a semi-unsupervised quantum learning protocol applicable to current (near term) quantum computers and quantum annealers, as well as emulations thereof.

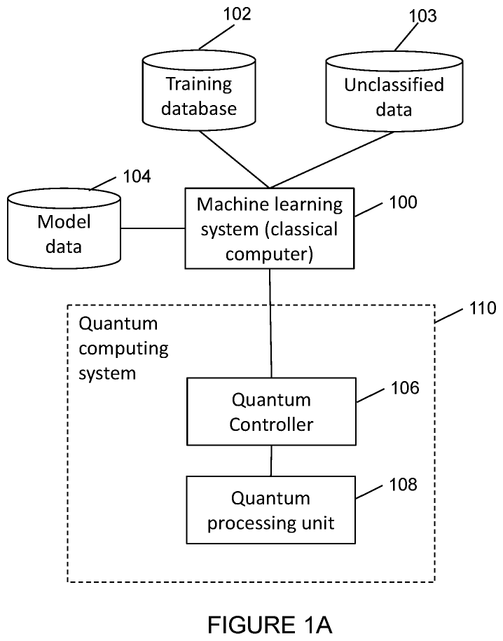

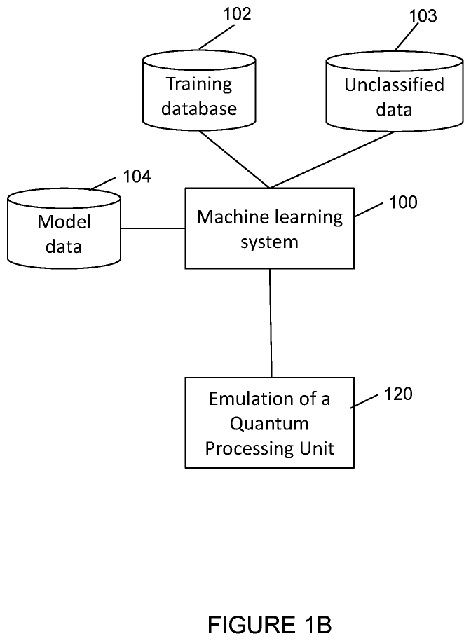

A system for implementing the described techniques in an actual quantum computer is illustrated in FIG. 1A.

The system includes a machine learning system 100, implemented as one or more classical computer devices, which controls the overall execution of the described learning and classification algorithms to train and apply a binary classifier. The learning system has access to a training database 102 which provides training samples for training the classifier (e.g. provided via an external database server). The learning system also stores model data derived during the model training process in a model dataset 104. The model data includes measurement data from the quantum computing system and probability distributions derived from the measurement data as described in more detail later. After training, the learning system can apply the trained classifier defined by the model data to unclassified data 103, comprising unlabelled data samples.

The machine learning system 100 interfaces with a quantum computing system 110. This involves a quantum controller 106 which controls execution of the quantum algorithms/circuits on the quantum processing unit 108. Any suitable quantum computing hardware may be used to implement quantum processing unit 108. In one embodiment, the quantum computing unit comprises a D-Wave™ annealer. Control Z operations are best suited to superconducting quantum hardware and in preferred embodiments, super conducting quantum annealers or super conducting quantum computers are used.

FIG. 1B shows an equivalent situation to that of FIG. 1A in which an emulation of a quantum processing unit 120 is used in place of the actual quantum computing system 110 in FIG. 1A.

The machine learning system 100, training database 102, model dataset 104 and unclassified data operate in an analogous manner to those in FIG. 1A and will not be discussed again.

The machine learning system 100 interfaces with the emulation 120, for example by way of a controller which in this case takes the form of e.g. a software application or even bespoke hardware (e.g. firmware) to control operations within the emulation 120. With careful use of emulation techniques, described in more detail below, high quality classifications, equivalent to the use of an actual quantum computer, can be extracted from the emulation.

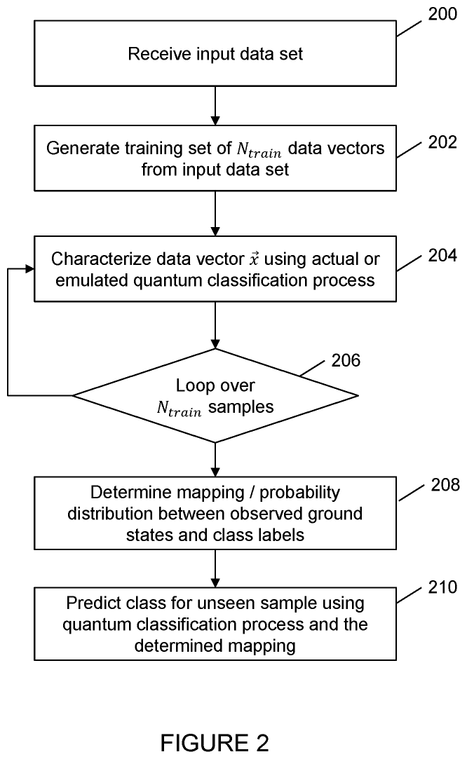

FIG. 2 illustrates a method for processing an input data set to derive a classification model and applying the classification model to unclassified data.

In step 200, the system receives an input data set, comprising a set of labelled input samples for which a binary classification model is to be derived. The input samples are retrieved from training database 102. Each input sample typically consists of a set of data attributes, also referred to as features, and a classification label. Thus, an input sample forms a data tuple <a₁, a₂, . . . aₙ, l> where a₁ . . . aₙ are the n sample attributes and l is the ground truth label, taking one of two values (e.g. 0 or 1) corresponding to the binary classification of the sample.

For example, in a medical application, attributes could include various patient attributes and diagnostic indicators, and the classification label could indicate presence or absence of a medical condition. In a fraud detection application, input samples could be transaction records, with attributes such as transaction participants, times, transaction values and the like, and the classification label could indicate whether a particular transaction was deemed fraudulent or normal.

In step 202, the system generates a set of Nₜᵣₐᵢₙ training samples based on the input data set. Typically, a subset of the input set is sampled. Sampling may be performed randomly. However, in a preferred embodiment, the process under samples the majority class, to obtain a balanced subset. Probability normalization may be applied for unbalanced datasets. Sampling is performed to reduce the number of operations that have to be performed on the quantum computing system. The sample size may thus depend on the size of the input data set and the available processing resources. In principle, sampling could be omitted if sufficient processing resources are available.

Each training sample forms a data vector \vec{x} comprising a set of vector elements or features, corresponding to the attributes of the input data. Additional pre-processing may be applied to the input samples, to derive the features of the data vector from the input samples, for example by normalising/scaling numerical features, encoding non-numerical features, performing dimensionality reduction and the like. In one example, categorical attributes in the input data may be encoded using a one-hot encoding. Other attributes such as strings may be dropped (though alternatively numerical representations of strings could be generated). This processing results in a set of numerical features.

In an embodiment, pre-processing involves performing Principal Component Analysis (PCA) to select the principal components of the feature space of the input samples. These principal components are a linear combination of the features resulting from a singular value decomposition of the data. Feature scaling may be applied using standard techniques prior to PCA as is known in the art. After PCA, the feature values are additionally scaled between (−a, a) where a is the scaling factor. This scaling step may, for example, use a MinMax scaler. The resulting scaled values of the principial components define the training samples as data tuples <f₁, f₂, . . . fₘ> where f₁ . . . fₘ are the m scaled features after PCA (such that m<n). The number m of features (principal components) may be selected based on the available actual or emulated quantum processing resources (since the number of qubits needed depends on the number of features as discussed later). Dimensionality reduction may be omitted where sufficient processing resources are available.

The processed training samples are referred to in the following as data vectors x. Note that the training label l is not included in \vec{x}. Thus, each training sample can be considered as producing a (scaled and PCA-transformed) data vector \vec{x} and an associated training label.

In step 204-206, the process loops over the Nₜᵣₐᵢₙ data vectors, applying a hybrid classical/quantum (actual or emulated) classifier algorithm to characterize each data vector x based on detecting ground state properties of a quantum representation of the data vector, as described in more detail later. This step is repeated until all training samples have been processed (test 206).

In step 208, the system uses the information obtained in the preceding steps to determine a mapping between ground state properties of the quantum representation and class labels for the two distinct binary classifications of the classifier. The mapping is based on a probability distribution of observed ground states for data vectors and their associated training labels.

In step 210, the classifier is used to predict classifications for previously unseen data samples, using the hybrid classifier and the determined mapping/probability distribution.

Step 204 involves characterizing each data vector x using a hybrid classical and quantum algorithm. Broadly, this involves the following stages:
encoding the data as an Ising Hamiltonian and mapping the data encoding to a set of real or virtual qubits in the actual or quantum processing unit; and
identifying and evaluating the ground state of the quantum system.

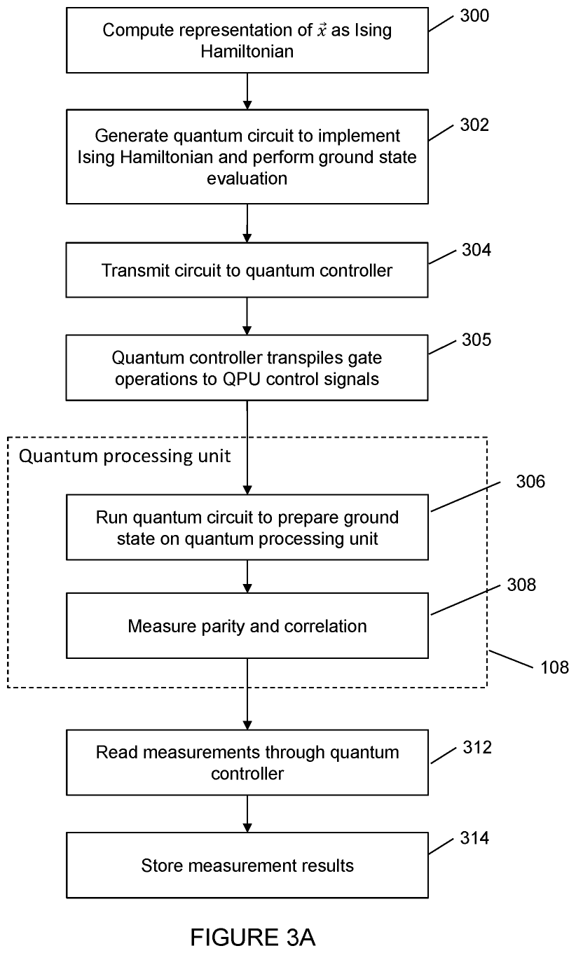

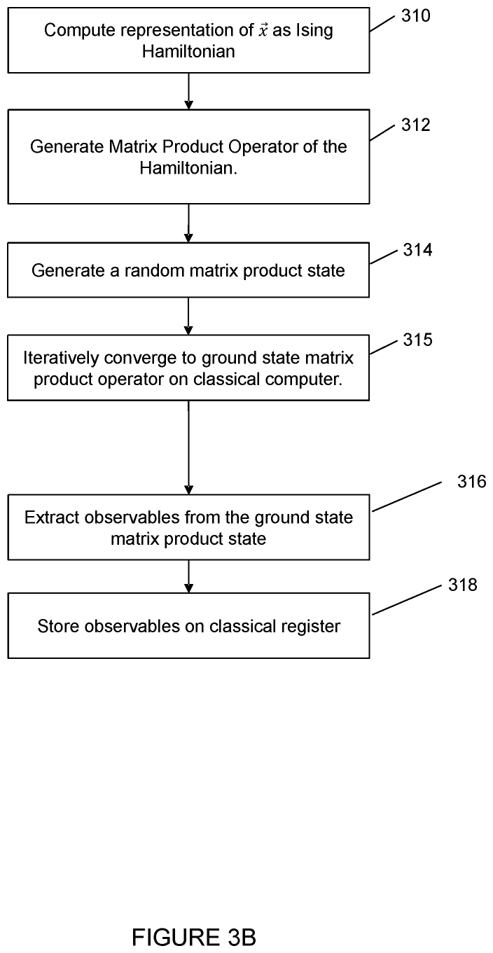

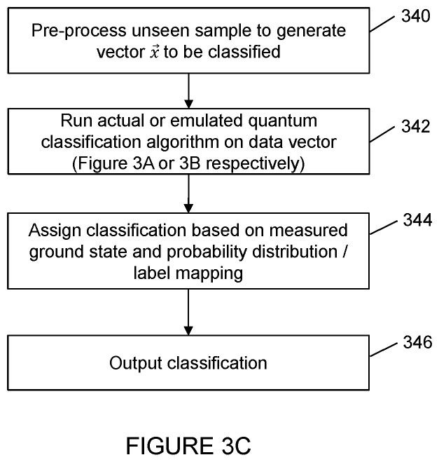

The principles underlying these aspects are described in the following sections, following which implementation of those principles in an example embodiment will then be described with reference to FIG. 3.

### Data Encoding

The encoding is based on mapping the classical data onto a quantum spin model using Hamiltonian encoding. Hamiltonian encoding forces classical data to become quantum in nature through re-representation as a disordered spin lattice.

The encoding scheme follows an approach outlined in V. Havlicek et al. “Supervised Learning with Quantum Enhanced Feature Spaces”, Nature 567 (2019) [4], which developed a data encoding strategy to perform quantum classification algorithms. Data non-linearity is enveloped by spin interactions on a lattice and non-linearity is expressed as entanglement which is beyond the reach of classical kernel routines.

In this approach, a data vector, \vec{x}, with N features is mapped to N qubits. A feature map is constructed with interaction degree S⊆[N] as V=U(\vec{x}) [symbol] ^{⊗N}U(\vec{x}) [symbol] ^{⊗N} where [symbol] is the Hadamard gate and

$$U ( \vec{x} ) = {e}^{i H} \qquad ( 1 )$$

$$H = {\sum }_{S ⊆ [ N ]} {ϕ}_{s} ( \vec{x} ) {\prod }_{i ∈ S} {\hat{Z}}_{i} . \qquad ( 2 )$$

The function ϕ_{S}(\vec{x}) encodes the data onto the coefficients of Pauli operations. When S≤2 the coefficients are

$${ϕ}_{i} ( \vec{x} ) = {x}_{i} \qquad ( 3 )$$

$${ϕ}_{i , j} ( \vec{x} ) = ( π - {x}_{i} ) ( π - {x}_{j} ) . \qquad ( 4 )$$

This encoding strategy is commonly known as the ZZ feature map whose pairwise interactions yield an Ising type Hamiltonian. In many real-world cases, classical data has no structure or symmetry, thus, the resulting Ising Hamiltonian represents a disordered spin lattice.

### Ground State Evaluation

The process involves obtaining the Eigen spectra of the Hamiltonian for each data vector x and extracting the ground state eigenvector, |ψ_{g}(\vec{x}) [symbol] . The eigen states of the Ising Hamiltonian are binary strings which reveal the low energy spin configuration on the lattice. The process detects short-range spin order by evaluating the pairwise spin correlation function,

$$C = \frac{1}{N} {\sum }_{i}^{N} 〈 {ψ}_{g} ( \vec{x} ) \vert {σ}_{i}^{z} {σ}_{i + Δ}^{z} \vert {ψ}_{g} ( \vec{x} ) 〉 , \qquad ( 5 )$$

where

$${σ}_{i}^{z}$$

is the Pauli z-operator for site i and Δ are the neighbors of site i. A lattice with ferromagnetic order yields a spin correlation C=1, and a lattice with antiferromagnetic order yields a spin correlation C=−1. The inventors have found that the ground state of the feature map demonstrates aₙ ordered configuration for both 1D and 2D lattice systems.

Projecting the feature space onto the Hamiltonian ground state provides a low dimensional representation of the data. The data sets are finite dimensional and we find the ground state is non-degenerate in all tested cases.

There exist two possible antiferromagnetic states with opposite spin configurations

$$\vert {ψ}_{g} ( \vec{x} ) 〉 \to \vert AF 1 〉 = \vert ↑ ↓ ↑ ↓ … 〉 \qquad ( 6 )$$

$$\vert {ψ}_{g} ( \vec{x} ) 〉 \to \vert AF 2 〉 = \vert ↓ ↑ ↓ ↑ … 〉 . \qquad ( 7 )$$

Ground state information is extractable algorithmically on a quantum computer. Ising model ground states can be prepared using quantum approximate optimization algorithm (QAOA) [14], imaginary time evolution [15], or algorithmic cooling [16, 17]. The process uses non-destructive measurements on the system qubits to extract information about the feature map ground state.

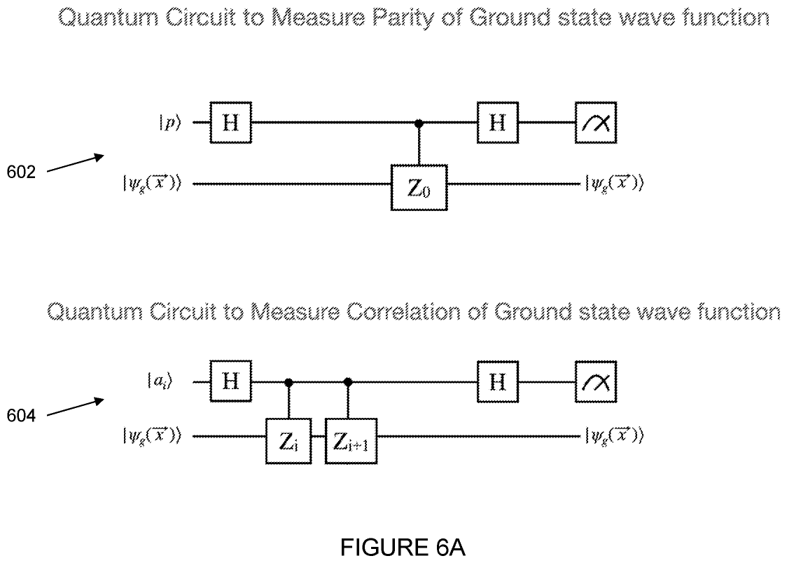

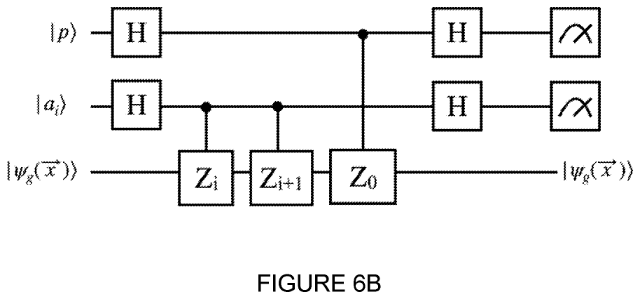

The ground state correlation is extracted from the wave function using N−1 auxiliary qubits as depicted in FIG. 6B. Specifically, FIG. 6B shows a quantum circuit describing the Hadamard test to obtain

$$〈 {σ}_{z}^{i} {σ}_{z}^{i + 1} 〉$$

on auxiliary qubit |aᵢ [symbol] and parity of the first qubit

$$〈 {σ}_{z}^{0} 〉$$

on auxiliary quoit |p [symbol] from the ground state |ψ_{g}(\vec{x}) [symbol] .

In addition, an additional auxiliary qubit is used to check the parity on the first system qubit in order to distinguish between the two antiferromagnetic states. The antiferromagnetic state is identified by a correlation C=−1 and the two antiferromagnetic states are distinguished by the parity,

$$〈 {σ}_{z}^{0} 〉 = 1 \to \vert AF 1 〉 \qquad ( 8 )$$

$$〈 {σ}_{z}^{0} 〉 = - 1 \to \vert AF 2 〉 . \qquad ( 9 )$$

Ground state evaluations are performed as described above over the subset of Nₜᵣₐᵢₙ data vectors, and a statistical distribution is built by counting the resulting states using the measurements. The normalized probability of a data vector yielding a particular antiferromagnetic ground state for a particular input classification label l is,

$$P ( \vec{x} \to AF 1 , l = 1 ) = \frac{{N}_{AF 1}^{1}}{{N}_{train}} \qquad ( 10 a )$$

$$P ( \vec{x} \to AF 2 , l = 1 ) = \frac{{N}_{AF 2}^{1}}{{N}_{train}} \qquad ( 11 a )$$

$$P ( \vec{x} \to ℛ , l = 1 ) = \frac{{N}_{ℛ}^{1}}{{N}_{train}} \qquad ( 12 a )$$

$$P ( \vec{x} \to AF 1 , l = 0 ) = \frac{{N}_{AF 1}^{0}}{{N}_{train}} \qquad ( 10 b )$$

$$P ( \vec{x} \to AF 2 , l = 0 ) = \frac{{N}_{AF 2}^{0}}{{N}_{train}} \qquad ( 11 b )$$

$$P ( \vec{x} \to ℛ , l = 0 ) = \frac{{N}_{ℛ}^{0}}{{N}_{train}} \qquad ( 12 b )$$

where [symbol] is the residual state space when C≠−1. A statistical distribution is built upon the antiferromagnetic states with each evaluated data vector and its associated label

$$P ( \vec{x} ) = P ( \vec{x} \to AF 1 , 0 ) + P ( \vec{x} \to AF 2 , 0 ) + P ( \vec{x} \to ℛ , 0 ) + P ( \vec{x} \to AF 1 , 1 ) + P ( \vec{x} \to AF 2 , 1 ) + P ( \vec{x} \to ℛ , 1 ) . \qquad ( 13 )$$

The process generates a distribution associated with each class. Computation of the distributions is described in more detail later.

The total variation distance (TVD) is a distance metric to compare the distributions between classes,

$$TVD ( P , Q ) = \frac{1}{2} {\sum }_{i}^{N} \vert {p}_{i} - {q}_{i} \vert , \qquad ( 14 )$$

where pᵢ and qᵢ are state probabilities. The system may use the TVD metric to quantify the distribution distance of the two data classes and use this information to predict the performance of the quantum classification tasks when data is encoded on varying spin lattices.

### Classification Process Implementation

FIG. 3A illustrates operation of the hybrid classification algorithm (as run in step 204 of FIG. 2 for the actual quantum classification process), in accordance with an implementation of the above principles. Steps 300-304 relate to the encoding stage and steps 306-312 perform the ground state evaluation stage.

In step 300, the machine learning system encodes the data vector x as an Ising Hamiltonian, as described above. The Ising Hamiltonian may be represented in a graph data structure, with nodes representing features and edges storing the coefficients of the Hamiltonian corresponding to feature interactions. For example, the Hamiltonian may be stored as a matrix of coefficients where the diagonal is the node coefficients and the off-diagonal is the interaction coefficients.

In step 302, a quantum circuit is created to implement the Ising Hamiltonian and evaluate the ground state on the quantum processing unit. The circuit consists of three sub-circuits.

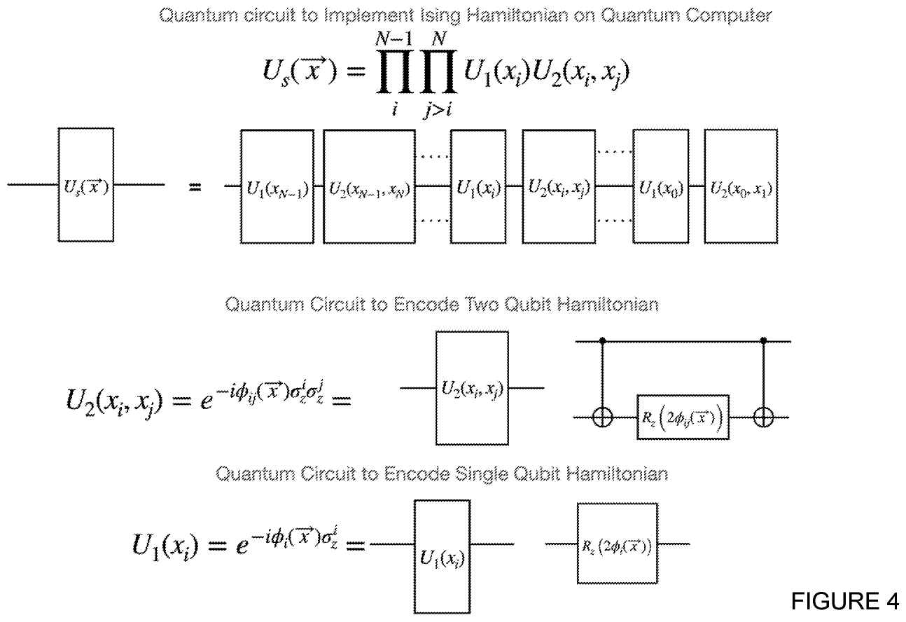

Firstly, the quantum circuit for implementing the Ising Hamiltonian is created as depicted in FIG. 4. This circuit maps the Ising Hamiltonian to a quantum system comprising a set of qubits, each qubit corresponding to a feature xᵢ with pairwise feature interactions represented as resonances between qubits. The single qubit data terms are encoded using a phase rotation gate and the two qubit data interactions are encoded using a controlled-NOT gate, followed by a phase rotation gate, which is followed by an additional controlled-NOT gate. The phase rotation gate is done by changing the rotation frame, known as a virtual-Z gate. The controlled-NOT gate is performed using a cross-resonance operation on superconducting qubits.

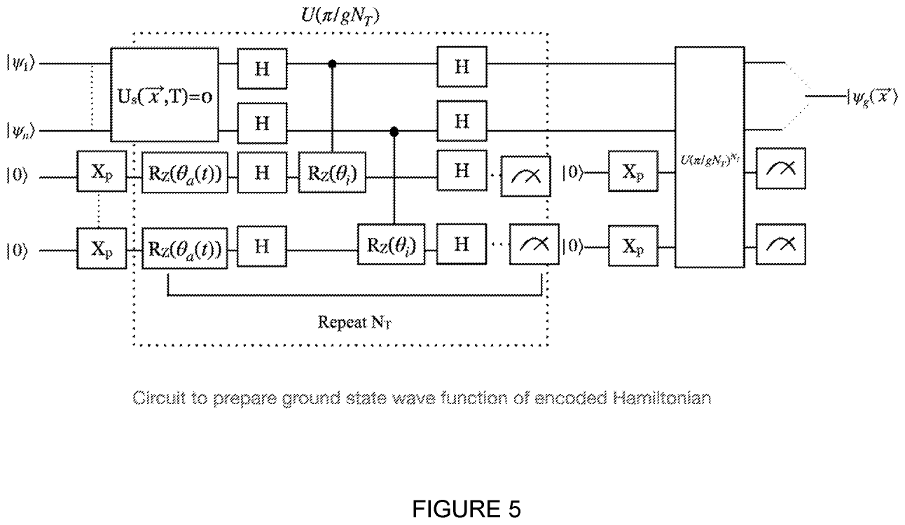

The second sub-circuit performs algorithmic cooling to prepare the ground state. An example of this circuit is shown in FIG. 5. However, as noted above, other approaches for preparing the ground state may be used.

The third sub-circuit obtains the ground state measurements used to determine correlation and parity of the ground state. FIG. 6A illustrates a quantum circuit 602 for measuring parity and a quantum circuit 604 for measuring correlation. In practice, these may be combined into a single circuit as depicted in FIG. 6B.

Where reference is made herein to “measuring” a property, this may involve measuring the property directly, or measuring one or more value(s) or characteristic(s) of the quantum system that are indicative of the property or from which the property can be computed, with the property itself calculated from the measurements in a post-processing step. For example, in the present embodiment, for the correlation, the expectation value is obtained on the quantum computer and the sum according to equation (5) is carried out as a post-processing step on the classical computer, e.g. the machine learning system 100, to determine the final correlation value C. References to “measuring” the correlation or other properties shall be interpreted accordingly.

The complete quantum circuit is created by combining the encoding circuit created for the Hamiltonian as per FIG. 4, the ground state preparation circuit of FIG. 5 and the measurement circuit of FIG. 6A/6B. Any suitable data representation may be used to represent the quantum circuit. In typical embodiments, circuit(s) may be represented using the QASM language (Quantum Assembly Language) or variants of that language.

In step 304, the machine learning system transmits the generated circuit to the quantum controller. In step 305, the quantum controller transpiles the gate operations of the quantum circuit into control signals for the quantum processing unit.

In step 306, the controller runs the quantum circuit (by applying the control signals) to set up the Hamiltonian as per the circuit of FIG. 4 and prepare the ground state on the quantum processing unit (as per the FIG. 5 circuit).

In step 308, the system measures parity and correlation of the resulting ground state (as per the FIG. 6A/6B circuit) by performing a Hadamard test. The Hadamard test extracts the real part of the expectation value through auxiliary qubit measurement. Summations are performed on a classical computer as described above.

In step 312 the measurements are output via the quantum controller to the machine learning system. The system derives the measurement results for parity and correlation from the raw measurements and stores the results for each data vector x in a results dataset in step 314.

It will be noted that, in this implementation, it is steps 306 and 308 that are performed by the quantum processing unit 108. The remaining steps are pre-processing or post-processing steps that are performed by one or more conventional (classical) computer devices running suitable software. In particular, in the FIG. 1A system, steps 300-304 and 314 may be performed by the machine learning system 100 while steps 305 and 312 may be performed by the quantum controller 106. However, processing tasks may be distributed between processing devices in a different way in other embodiments.

Returning to FIG. 2, once the FIG. 3A process has been performed for all Nₜᵣₐᵢₙ data vectors x in step 204/206, the measurement results obtained from the quantum processing unit are further processed in step 208.

The measurement results include for each processed data vector xi the correlation value C and the parity

$$〈 {σ}_{z}^{0} 〉 .$$

Since C=−1 corresponds to the lowest energy state (ground state), most or all of the processed vectors would be expected to have correlation C=−1. However, error cases may in practice produce a different correlation value (referred to above as the residual state space [symbol] for which C≠−1). Such data vectors may be considered as representing samples that could not be reliably classified into one of the two distinct classes.

For the processed data vectors with C=−1, the parity distinguishes the two possible antiferromagnetic ground states, identified as AF1 and AF2. Furthermore, each data vector is associated with a training label from the corresponding input sample.

In step 208, the learning system counts the occurrences of each combination of detected ground state and training label across the set of processed data vectors to derive a probability distribution for each class label. For example, assuming two possible training labels “ClassA” and “ClassB”, the following probability distribution is computed for possible combinations of ground states ψ_{g} and class labels c:

| P(ψ_{g}(\vec{x}), c) | AF1 | AF2 |
|---|---|---|
| ClassA | P(AF1, ClassA) | P(AF2, ClassA) |
| ClassB | P(AF1, ClassB) | P(AF2, ClassB) |

Where:

$$P ( AF 1 , ClassA ) = \frac{Number of vectors with ground state AF 1 and training label ClassA}{{N}_{train}}$$

$$P ( AF 2 , ClassA ) = \frac{Number of vectors with ground state AF 2 and training label ClassA}{{N}_{train}}$$

$$P ( AF 1 , ClassB ) = \frac{Number of vectors with ground state AF 1 and training label ClassB}{{N}_{train}}$$

$$P ( AF 2 , ClassB ) = \frac{Number of vectors with ground state AF 2 and training label ClassB}{{N}_{train}}$$

In the above, ferromagnetic ground states (C=1) are ignored (as these correspond to high-energy states and are thus not expected to occur). Any remaining states for which C≠−1 are considered as the residual state space [symbol] , for which the probability P( [symbol] ,c) is usually zero (or close to zero).

The above probability distribution essentially forms the classification model which is then applied to classify unseen samples. Specifically, the probability distribution defines a mapping which maps a given observed ground state for a data vector x to a class label.

In step 210, the classifier is applied to one or more unseen samples from a source of unclassified data 103. These are samples matching the training samples in training database 102 but without ground truth classification labels. Unseen samples may be obtained from a database, or the classifier may be applied in real-time to a data sample as it is generated by another system. For example, for e-commerce fraud classification, an e-commerce transaction system may generate a transaction record as part of a processed transaction and submit the transaction record to the machine learning system for classification in real time, or may store transaction records in a database for offline batch processing by the classifier.

In FIG. 3B, an example of a method for providing the hybrid classification algorithm is shown, as run in step 204 of FIG. 2 for the emulated quantum classification process, in accordance with an implementation of the above principles. Note that much of the interpretation of the outputs and the detail of encoding is directly analogous, so the comments above in respect of FIG. 3A apply analogously here and will not be repeated. Steps 310-312 relate to the encoding stage and steps 314-318 perform the ground state evaluation and output stage.

In step 310, the machine learning system encodes the data vector x as an Ising Hamiltonian, as described above. The Ising Hamiltonian may be represented in a graph data structure, with nodes representing features and edges storing the coefficients of the Hamiltonian corresponding to feature interactions. For example, the Hamiltonian may be stored in the emulated quantum computing environment as a matrix of coefficients. Although any structure may be used to encode this information, matrix- and tensor-based systems are a well understood formalism for storing this information.

Proceeding with the matrix and tensor formalism as an example, the Hamiltonian is constructed into a tensor which represents the Hamiltonian of the model system, for example as used here the Ising Hamiltonian. The high rank tensor representing the energies and interactions in the system can then be represented, as in step 312, as a matrix by applying the Matrix Product Operator (MPO) formalism to represent the input data vector. This formalism operates to contract sparse tensors into more convenient matrices. The MPO therefore operates analogously to the quantum circuit, in that both can be expressed as a matrix encapsulating the energy interactions of the model quantum system representing the input data. Links to the physical system being emulated (e.g. the Ising Hamiltonian) are encapsulated in indices, for example to reference site locations in the Ising chain, spin states of those sites, etc. Additional indices are used to encapsulate the interrelation between the sites, and thereby to preserve the structure of interactions in the system. The dimensionality of these additional indices can be set at a particular value (e.g. to limit computational complexity by discarding the least strong correlations) or by using Singular Value Decomposition (SVD) to determine the required dimensionality to encapsulate the interactions in the system.

Next, in step 314, a Matrix Product State (MPS) is created as part of the process for finding the lowest energy state of the MPO. The random MPS is a randomized state of the system, for example in the Ising model, a set of randomly oriented (selected from up/down) spins. The MPS will have physical dimensions equivalent to a number of lattice sites in the Ising Hamiltonian, where this is the Hamiltonian used. An iterative process such as Density Matrix Renormalisation Group (DMRG) is the used in step 315 used to converge on a form of the MPS which is the eigenvector with the lowest eigenvalue of the MPO.

The DMRG subroutine is applied to each data vector and is used to obtain the low energy (ground) state. The DMRG algorithm performs a set number of sweeps across the MPS until the MPS converges to the lowest eigenvalue of the MPO. The process of a single sweep is to optimize two nearest neighbour tensors at a time. This is done by combining these two tensors into a single tensor, multiplying by the MPO that matches those two tensors, refactoring the tensor using an eigensolver or gradient descent approach, such that the new tensor lowers the eigenvalue of the MPO. The tensor is then returned to MPS form (i.e., a full vector of the system, rather than encapsulating only two nearest neighbour tensors) using SVD. Following this procedure the next neighbouring tensors are optimized. This process is repeated until the lowest eigenvalue of the MPO is obtained given the MPS. This completes step 315.

The matrix product state (MPS) yielded from the iterative (e.g. DMRG) algorithm is then a projection of the input data, as encoded on the MPO, onto the lowest energy state of the Hamiltonian. For the Ising Hamiltonian, given constraints described elsewhere in this document, this can result in two possible spin configurations, represented as the low energy MPS. The identification of these spin configurations is obtained through the aforementioned observables. In this way, step 316 allows the identified ground state to be used either to identify a correlation between training data and a category of that data, for training the system, or previously unseen data can be classified by identifying properties of the ground state and comparing to information extracted from previously classified data sets during training, as set out elsewhere herein.

In other words, from this ground state MPO, step 316 can be enacted in which observables are extracted from the MPS. Observables such as the correlation between spin states on the lattice sites are obtained by taking expectation values of the MPS with the observable expressed in MPO form. This correlation is, as noted elsewhere, useful both in training a classifier and in using a trained classifier to classify previously unseen data. The extracted properties can be stored on a local register (step 318), for use locally, transmitted elsewhere for further processing, and so forth.

Classification of an unseen sample is illustrated in FIG. 3C. In step 340, any necessary pre-processing of data (matching the pre-processing performed during the training phase as described above) is performed for the unseen sample(s) to derive corresponding data vector(s) x. For example, the sample may be transformed using the previously obtained PCA transformation and feature scaling may be applied as previously described.

After pre-processing, the resulting data vector x is processed in step 342 using the hybrid classification algorithm previously described. In particular, the vector is processed using the FIG. 3A or FIG. 3B process, by computing the Ising Hamiltonian representation, mapping that to the quantum computation environment, preparing the ground state and measuring the ground state correlation and parity.

The ground state evaluation results in measurement of either the AF1 or AF2 ground state for the data vector and this is mapped to the corresponding classification label using the label mapping determined in the training phase in step 344.

In particular, the system selects the class label with the higher probability for the detected ground state as specified by the determined probability distribution. For example, if the detected ground state is AF1, them the system assigns ClassA if P(AF1,ClassA)>P(AF1,ClassB), and assigns ClassB if P(AF1,ClassA)<P(AF1,ClassB). The same process is applied analogously where the detected ground state is AF2.

Note, in practice, the probabilities do not need to be evaluated for each classification. Instead, the system may derive a fixed label mapping based on the determined probability distribution that maps each ground state to the class label associated with the higher probability for that ground state. This mapping may, for example, be determined in step 208 of FIG. 2. The fixed mapping is then applied in step 210/344 by simply assigning the class label given for the detected ground state in the label mapping. Thus, references herein to a mapping may include both the original probability distribution and a label mapping derived from the probability distribution.

The resulting assigned classification label is output as the classification of the unseen data sample in step 346. This process is repeated for each unseen sample that is to be classified.

For example, where the classifier is integrated into a transaction processing system, the machine learning system may apply the hybrid classifier to a transaction record and return the classification result in real-time to the transaction processing system, to allow the transaction processing system to respond accordingly (e.g. by cancelling or reversing the transaction, creating a fraud alert etc, in the case of a transaction record classified as fraudulent).

The FIG. 3C classification process may also be used on a labelled test set to evaluate classification performance, as is well known in the machine learning field.

### Processing Device

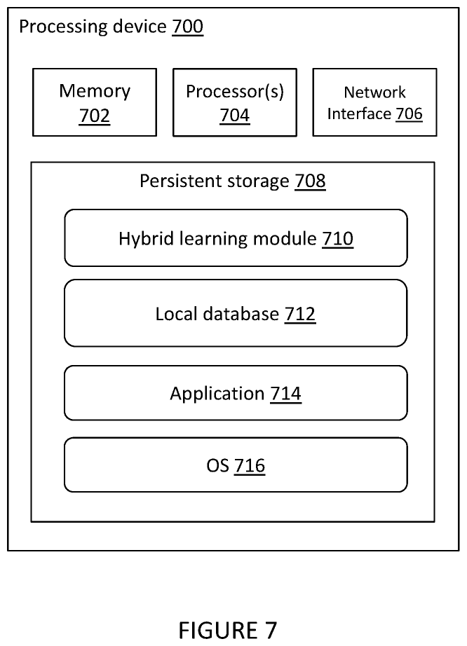

FIG. 7 illustrates a (classical) computer device for implementing the machine learning system 100 of FIG. 1.

The computer device 700 may be based on conventional workstation or server hardware and as such includes one or more processors 704 together with volatile/random access memory 702 for storing temporary data and software code being executed.

A network interface 706 is provided for communication with other system components. For example, the computer device may communicate via the network interface with the external training database 102 and unclassified data source 103, for example, an e-commerce transaction system generating e-commerce transactions to be classified as “fraudulent” or “non-fraudulent”. The computer device further communicates via the network interface with quantum computing system 110 (to run quantum circuits on the quantum processing unit 108 via the quantum controller 106) or the emulation 120 of a quantum computing system. Communication may occur over one or more networks (e.g. Local and/or Wide Area Networks, including private networks and/or public networks such as the Internet).

In an embodiment, the quantum computing system, or the emulation thereof as appropriate, may be provided as a remote system, accessible via a cloud-based (quantum computing) service.

Persistent storage 708 (e.g. in the form of hard disk storage, optical storage and the like) persistently stores software and data for performing various described functions. In an example, this includes a hybrid learning module 710 implementing described functions for processing the training samples (and unseen data samples) for submission to the quantum computation environment and processing the ground state measurements obtained in the quantum computation environment to derive the classification model (in the form of the probability distribution/label mapping) and apply the model to unseen samples.

A local database 712 is stored in the persistent storage to store data used by the hybrid learning module, such as training samples, pre-processed/encoded data samples, measurement data and associated processing results and model data etc.

The device may further provide a user application 714 (e.g. as a local application, client/server or web-based application backend etc.) providing an interface for a user to interact with the system, including to select/load training data sets, initiate the training phase, and/or apply the trained model to unseen data samples.

The persistent storage further includes a computer operating system 716 and any other software and data needed for operating the computing device. The device will include other conventional hardware components as known to those skilled in the art, and the components are interconnected by one or more data buses (e.g. a memory bus and I/O bus).

While a specific architecture is shown and described by way of example, any appropriate hardware/software architecture may be employed to implement the machine learning system.

Furthermore, functional components indicated as separate may be combined and vice versa. For example, the various functions may be performed by a single device 700 or may be distributed across multiple devices. As a concrete example, one or more databases could be stored at a separate database server.

It will be understood that the present invention has been described above purely by way of example, and modification of detail can be made within the scope of the invention.

For example, while described in relation to binary classifications, the described techniques may be extended to classification schemes with more than two classes. Additionally, the techniques may be extended to other quantum representations/encodings of the input data, for example using other forms of Hamiltonian representation.

### APPENDIX—EVALUATION

The following sections describe some experimental evaluation results for the above-described techniques. The evaluations were performed using simulation of the quantum circuits.

We investigate three different data sets used to test classifier performance; these include the UC Irvine breast cancer data set [7], credit card fraud detection data set [8], and e-commerce data set [9]. Data is encoded on 1D and 2D Ising spin lattices, and we evaluate the ground state of these data Hamiltonians using exact diagonalization. We find that the ground state solution yields an antiferromagnetic phase with two non-degenerate antiferromagnetic states. We build a statistical distribution by evaluating the model ground states over a subset of data. We compare the distributions of the two classes using total variation distance and find model success is correlated to the large distribution differences. Our results imply antiferromagnetic order is useful for data class discrimination. We address order stability with noisy data, and find it is robust to small amounts of noise. We also find correlation is influenced by data scaling which explains the benefits of the scaling parameter used in feature encodings.

The Kaggle hosted credit card transaction data set and the e-commerce data set are used to benchmark models at detecting fraud. Classical machine learning algorithms perform far better on the credit card transaction data set, while the e-commerce dataset is more difficult to classify. One intention of our work is to gain insights to why the e-commerce data set is more difficult by evaluating its expression on the spin lattice. In addition to the fraud data sets, we evaluate the UCI breast cancer data set to verify our results are general to other forms of data. Data is downsampled from the full set to obtain a balanced subset. Larger samples of Nₜᵣₐᵢₙ will reduce sampling error in the distributions with an overhead of more circuit simulations. We perform Principal Component Analysis (PCA) to select the principal components of the feature space. These principal components are a linear combination of the features resulting from a singular value decomposition of the data. The data is scaled between (−a, a) where a is the scaling factor. A data vector x is mapped to the Hamiltonian in Equation 1 with S={1,2} for three different lattice configurations: 1D chain, 2D square lattice, 2D triangle lattice.

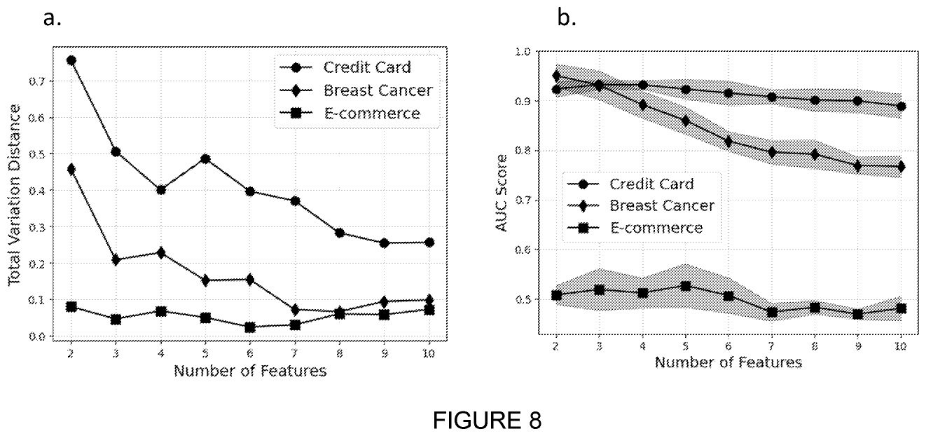

Some evaluation results are illustrated in FIGS. 8 to 12. These Figures will first be described briefly here, after which results are discussed in relation to those Figures in the following sections.

FIG. 8 illustrates: a) total variation distance between distributions of antiferromagnetic ground states associated with separate classes for increasing number of features and b) AUC score of quantum support vector machine for increasing feature number. This was calculated for 3 different sets of binary classification data, each of which were balanced then sampled down to 200 data points. Each set was encoded on one-dimensional lattice using linear entangling map.

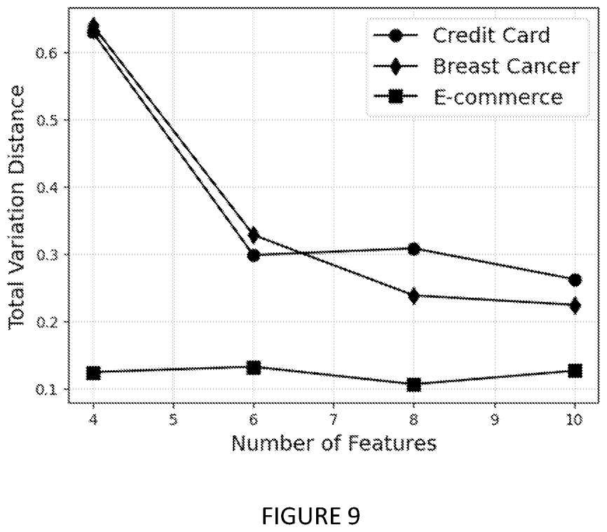

FIG. 9 illustrates total variation distance between distributions of antiferromagnetic ground states associated with separate classes for increasing number of features. This was calculated for 3 different sets of binary classification data, each of which were balanced then sampled down to 200 data points. Each set was encoded on 2-dimensional square lattice ladder entangling map.

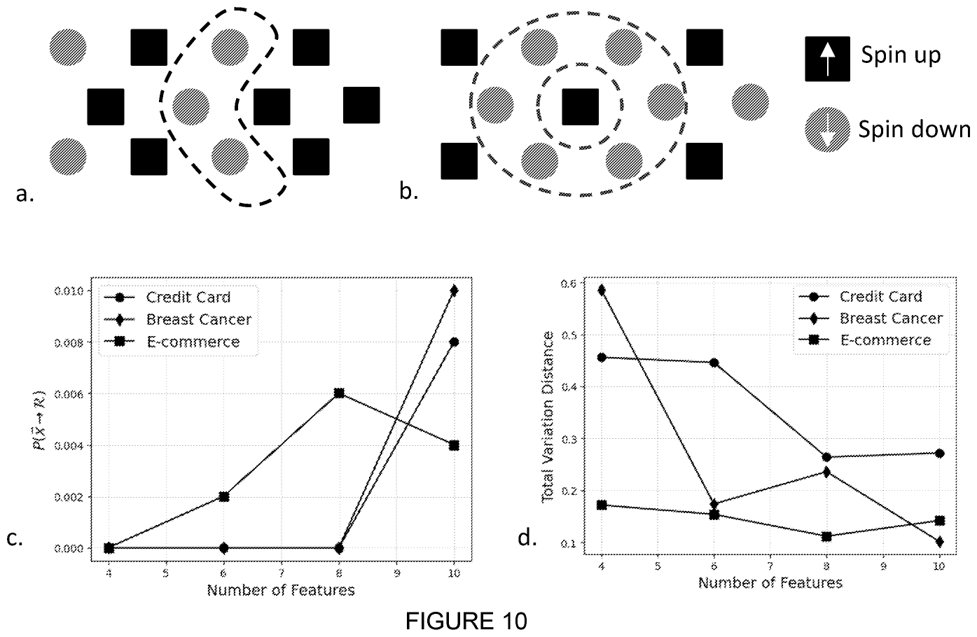

FIG. 10 illustrates: a) Zig-zag ferromagnetic order b) graphene-like ferromagnetic order on 3× 4 triangle lattice. Squares represent spin up and circles represent spin down. c) Probability of residual states P( [symbol] ) for the three data sets encoded onto a triangle lattice. d) Total variation distance between distributions of antiferromagnetic ground states associated with separate classes for increasing number of features. This was calculated for 3 different sets of binary classification data, each of which were balanced then sampled down to 200 data points. Each set was encoded on triangle lattice ladder entangling map.

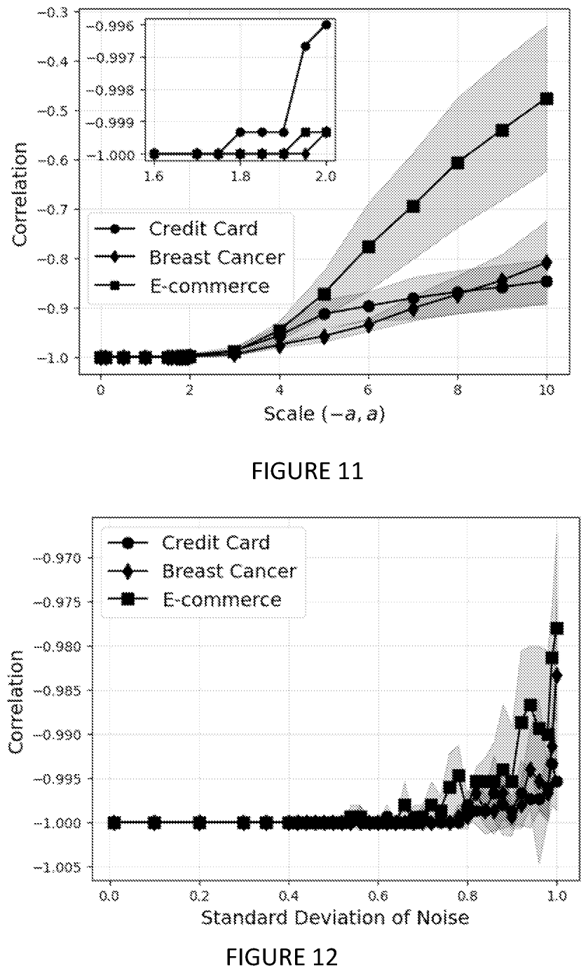

FIG. 11 illustrates one-dimensional linear entangling map ground state spin correlation with increasing scaling parameter a. Shown for 3 different datasets, each of which were balanced then sampled down to 200 data points and 4 features. (Inset) higher resolution plot to examine order-disorder transition point do.

FIG. 12 illustrates spin correlation with increasing standard deviation of Gaussian noise added to the data.

One-Dimensional Encoding—The ground state of the linear entanglement map is always anti-correlated such that P(\vec{x}= [symbol] )=0. We evaluate the TVD between distributions associated with separate classes (e.g. fraudulent vs. genuine and malignant vs. benign) in FIG. 8a. TVD is largest for the credit card transaction data set meaning the distribution of the fraudulent transactions on the antiferromagnetic state space is considerably different than the distribution of genuine transactions. Thus, the Ising model is capable of discriminating the two classes, albeit with low probability. In contrast, the distribution difference for the e-commerce data is near zero and the Ising model is unable to discriminate the classes. This is interesting because the e-commerce data is known to challenge classical models as well. Our model is a technique to demonstrate the similarity between the classes in high-dimensional non-linear space. One expects the data non-linearity is very complex and higher-order non-linear models are needed to discriminate the data. The breast cancer data set falls in between the TVDs of the two other data sets, so the Ising model is still able to discriminate between malignant and benign instances.

We perform quantum support vector classification tasks on the three data sets to extrapolate meaning behind the linear entangling map TVD. We hypothesize better model discrimination when the data set exhibits a large TVD. The Qiskit and Scikit-learn libraries are used to build the quantum and classical machine learning algorithms [18, 19]. The objective is not to find the best fitted model, rather to determine the QML algorithm performance given our knowledge of the distribution difference.

Quantum kernels evaluate the distance between data vectors by determining the overlap between the data points in feature space

$${K}_{ij} = 〈 ϕ ( {\vec{x}}_{j} ) \vert ϕ ( {\vec{x}}_{i} ) 〉 . \qquad ( 15 )$$

The kernel, obtained by rotating in the eigenbasis of the encoded spin lattice, inputs to a classical Support Vector Classifer (SVC) which optimizes the support vectors to separate the training data classes. We find support vector classifiers have superior performance to heuristic quantum neural networks in classification tasks. Area under the curve (AUC) determines the model discrimination quality to correctly classify new data vectors. We evaluate and compare the AUC metric using an SVC with a quantum kernel that evaluates data distance in the Ising lattice Eigen space. The quality of this metric is correlated to the ground state distribution TVD.

We sample the data, undersampling the majority class, to obtain a balanced subset and partition the sample into training and test sets. We leave hyper-parameters fixed for all three data sets. The scaling parameter is a=1 for all data sets. We evaluate the kernel performance for increasing number of principle component vectors mapped to qubits using the linear chain Ising encoding (FIG. 8b). The QSVC performs better on the credit card transaction data than the breast cancer dataset which is contrary to the performance of the classical SVC but inline with the ground state distribution TVD. The QSVC performs worst on the E-commerce dataset. Our results, imply the ground state of the feature map can provide insight into the outcome of quantum classification algorithms using the Ising type feature map.

Two-Dimensional Encoding—The resulting anti-correlated ground state extends to data encoded on two dimensional spin lattices. Ground states of a data vector mapped to a square ladder results in perfectly anti-correlated spin states on the ladder. TVDs of the breast cancer data and credit card fraud data are similar, and we see a reduced TVD from the one-dimensional chain encoding (FIG. 9). Preference for nearest neighbor entanglement on a chain could result from the interplay of principal component analysis and the interplay of non-linear feature expression. As a result, the QSVM has worse performance using the square ladder entanglement strategy.

There are cases where P(x→ [symbol] )>0 and the ground states are no longer anti-correlated. Such is the case with the triangle lattice entangling map. Antiferromagnetic ground states on triangle lattices exhibit geometric frustration characterized by high ground state degeneracy [20]. The disorder from the classical data encoded on the triangle lattice breaks this degeneracy, and we find one of the ordered antiferromagnetic states as a solution to the data encoding. Evaluating the probability of the residual state space on the triangle ladder show a size dependence for both the breast cancer data and the credit card fraud data (FIG. 10c). The ecommerce data, in contrast, exhibits residual probability for small lattice sizes. For all of these data sets P( [symbol] ) is small. We extend our model into a fully 2D model and characterize the spin order on a 3×4 triangle lattice. The most typical state is the zig-zag phase on the triangle lattice (FIG. 10a). In addition, we find certain instances have a hexagonal, graphene-like ferromagnetic order on the spin lattice (FIG. 10b). This means our data vectors subside in different sectors of a ground state phase diagram with different antiferromagnetic ordering. Connecting the physics of these phases with the classical data vectors that generate them can potentially lead to new insights about the data. The TVD for the triangle lattice diminishes rapidly for the datasets rather than stabilizing like the square lattice and one-dimensional chain (FIG. 10d).

### Order Stability and Generalization

Stability of the antiferromagnetic state results in better performance of the ZZ feature map. Our original curiosity arose due to the scaling parameter introduced in the time-evolution operator to improve quantum distance measures between data points [21], and we sought to determine the physical meaning behind this scaling parameter.

Parameter Scaling-Quality of the Ising feature map reduces significantly if data isn't scaled appropriately. Ref[21] introduces a scaling hyperparameter a in the unitary evolution operator,

$$U ( a , \vec{x} ) = {e}^{i a H ( \vec{x} )} . \qquad ( 16 )$$

We evaluate the spin correlation of the ground state of scaled data encoded on the 1-dimensional linear entangling map (FIG. 11). The antiferromagnetic order collapses as data is scaled to larger values seen by the diminishing correlation. The credit card fraud data decorrelated at a lesser value a than the breast cancer and e-commerce data. In particular, the state space distributions of the two data classes of data differ enough that classification is no longer possible. The degree of divergence beyond this point is data dependent. The e-commerce dataset is less robust to the scaling, therefore, it diverges at a much faster rate in comparison to both the credit card and breast cancer datasets.

The destruction of correlation in the model is likely to arise from strong lattice disorder, thus, the lattice potential no longer favors antiferromagnetic order. This transition point, a₀, appears inconsistent between datasets though very similar, perhaps due to a physical phase transition. Although initial thoughts assumed this transition would happen around a₀=π, it is clear this instability occurs at a smaller scaling parameter.

Noise—The role of noise in data is important for model generalization. We assess the stability of antiferromagnetic order when Gaussian noise is added to the data (FIG. 12). We see that the spin correlation of the ground states begins to diverge for higher levels of noise. The antiferromagnetic nature of the ground state is robust to Gaussian noise with a standard deviation σ≤0.5, however, this is broken for highly noisy data. Similarly to scaling, we see the E-commerce data set is less robust to noise.

### LIST OF CITATIONS

[1] M. Schuld, R. Sweke, and J. J. Meyer, Phys. Rev. A 103, 032430 (2021).
[2] E. Peters and M. Schuld, ArXiv X (2022).
[3] M. Schuld and F. Petruccione, Supervised Learning with Quantum Computers (Springer, 2018).
[4] V. Havlicek, A. D. Crcoles, K. Temme, A. W. Harrow, A. Kandala, J. M. Chow, and J. M. Gambetta, Nature 567 (2019).
[5] L. H. Gilpin, D. Bau, B. Z. Yuan, A. Bajwa, M. Specter, and L. Kagal, IEEE 5th International Conference on data science and advanced analytics (DSAA) (2018).
[6] C. Rudin, Nature Machine Intelligence 1, 206215 (2019).
[7] “Uci machine learning repository: Breast cancer data set,” https://archive.ics.uci.edu/ml/datasets/Breast20Cancer.
[8] “Kaggle credit card fraud detection,” https://www.kaggle.com/datasets/mlg-ulb/creditcardfraud.
[9] “Kaggle fraud e-commerce,” https://www.kaggle.com/vbinh002/fraud-ecommerce.
[10] M. Schuld and N. Killoran, Phys. Rev. Lett. 122 (2019).
[11] S. Altares-Lopez, A. Ribeiro, and J. J. Garcia-Ripoll, Quantum Science and Technology 6, 045015 (2021).
[12] A. D. P. Massimiliano Incudini, Francesco Martini, ArXiv, 2209.11144 (2022).
[13] E. Torabian and R. V. Krems, ArXiv, 2203.13848 (2022).
[14] E. Farhi, J. Goldstone, and S. Gutmann, ArXiv, 1411.4028 (2014).
[15] M. Motta, C. Sun, A. T. K. Tan, M. J. O. Rourke, E. Ye, A. J. Minnich, F. G. S. L. Brandao, and G. K.-L. Chan, Nature Physics 16, 205 (2020).
[16] M. Metcalf, E. Stone, K. Klymko, A. F. Kemper, M. Sarovar, and W. A. de Jong, Quantum Science and Technology 7, 025017 (2022).
[17] S. Polla, Y. Herasymenko, and T. E. O'Brien, Phys. Rev. A 104, 012414 (2021).
[18] “Qiskit,” https://www.qiskit.org.
[19] “Scikit learn,” https://www.scikit-learn.org.
[20] A. Ramirez, Nature 421, 483 (2003).
[21] J.-E. Park, B. Quanz, S.Wood, H. Higgins, and R. Harishankar, 34th Conference on Neural Information Processing Systems First Workshop on Quantum Tensor Networks in Machine Learning, First Workshop on Quantum Tensor Networks in Machine Learning (2020).

1. A method comprising:
deriving, from an input data set, a plurality of training samples, each training sample comprising a data vector having a plurality of features and a class label;
processing each data vector using a quantum classification process including:
encoding the data vector on a set of real or virtual qubits of a quantum computation environment, the quantum computation environment being a quantum processing unit having real qubits or an emulation of a quantum processing unit having virtual qubits, to form a quantum system representing the data vector;
executing operations in the quantum computation environment to prepare the ground state of the quantum system;
determining one or more properties of the ground state; and
identifying one of a set of possible ground states corresponding to the data vector based on the one or more properties;
the method further comprising determining, based on the identified ground states and class labels for the training samples, a mapping that maps ground states to class labels; and
storing the mapping for use in classifying further data samples.

2. A method according to claim 1, wherein encoding the data vector comprises:
encoding the data vector as a Hamiltonian, preferably an Ising Hamiltonian; and
implementing the Hamiltonian on the set of qubits.

3. A method according to claim 1 or 2, wherein the one or more properties comprise one or both of:
a correlation property;
a parity property.

4. A method of claim 3, wherein the correlation property indicates pairwise spin correlation between real or virtual qubits of the quantum system.

5. A method according to claim 3 or 4, wherein the correlation property comprises a value indicating one of: a lattice with ferromagnetic order; and a lattice with antiferromagnetic order.

6. A method according to any of claims 3 to 5, wherein the parity property distinguishes first and second antiferromagnetic states with opposite spin configurations.

7. A method according to claim 6, wherein identifying a ground state comprises associating a first ground state with a parity value indicative of the first antiferromagnetic state, and a second ground state with a parity value indicative of the second antiferromagnetic state.

8. A method according to any of the preceding claims, wherein determining a mapping comprises determining the mapping for each of a plurality of labels, preferably for two labels of a binary classification scheme.

9. A method according to any of the preceding claims, wherein determining the mapping comprising computing a probability distribution indicating probabilities for different combinations of ground states observed for given data vectors and the corresponding class labels associated with those data vectors.

10. A method according to claim 9, wherein the probability distribution specifies, for each class label, probabilities of observing a plurality of respective ground states for data vectors associated with the class label.

11. A method according to claim 10, wherein the probability distribution specifies probabilities of observing two distinct antiferromagnetic ground states for each of two binary class labels.

12. A method according to any of claims 9 to 11, comprising determining, for each class label, the number of occurrences of each ground state for data vectors having the class label that was identified by the quantum classification process; and computing the probabilities based on the determined occurrences.

13. A method according to any of claims 9 to 12, wherein determining or using the mapping comprises mapping each of a set of observable ground states to a class label having the highest probability for that ground state according to the probability distribution.

14. A method according to any of the preceding claims, comprising:
receiving a further data sample;
deriving a data vector from the further data sample;
processing the data vector using the quantum classification process to identify a ground state for the data vector;
determining a class label for the data vector based on the identified ground state using the determined mapping between ground states and class labels; and
outputting the class label as a classification of the further data sample.

15. A method according to claim 14, wherein determining a class label using the mapping comprises selecting the class label having the highest probability for the identified ground state according to the mapping.

16. A method according to any of the preceding claims, wherein the encoding step comprises: computing coefficients of the Ising Hamiltonian; and storing a data representation of the Hamiltonian comprising the coefficients, the data representation optionally comprising a graph or matrix representation.

17. A method according to any of the preceding claims, wherein processing a given data vector using the quantum classification process comprises:
generating a first quantum circuit for implementing the encoding of the data vector (such as the Ising Hamiltonian) in the quantum computation environment;
combining the first quantum circuit with a second quantum circuit configured to prepare the ground state of the quantum system; and
transmitting the combined quantum circuit to a controller associated with the quantum computation environment.

18. A method according to claim 17, wherein the combining step further combines the first and second quantum circuits with a third quantum circuit for obtaining the one or more ground state properties.

19. A method according to claim 18, wherein the third quantum circuit is configured to obtain one or more measurements indicative of one or both of: the spin correlation, and the parity of the ground state.

20. A method according to any of claims 17 to 19, comprising controlling, by the controller, the quantum computation environment to perform the quantum classification process in accordance with the quantum circuit(s).

21. A method according to any of claims 17 to 20, further comprising, using the controller, obtaining one or more measurements indicative of the one or more ground state properties from the quantum computation environment and storing the measurements and/or ground state properties.

22. A method according to any of the preceding claims, wherein measurement(s) indicative of the one or more ground state properties are measured using one or more real or virtual auxiliary qubits and/or are measured non-destructively.

23. A method according to any of the preceding claims, wherein one or more of the steps of deriving training samples, encoding data vectors, identifying a ground state, and/or determining a mapping, are performed by a machine learning system comprising one or more classical computing devices.

24. A method according to any of the preceding claims, wherein implementation of the encoding (e.g. Ising Hamiltonian) on a set of real or virtual qubits, preparation of the ground state and/or obtaining one or more measurement(s) indicative of one or more ground state properties are performed in the quantum computation environment.

25. A method according to any of the preceding claims, wherein deriving a plurality of training samples from an input data set comprises selecting a subset, preferably a balanced subset, of training samples from the input data set.

26. A method according to any of the preceding claims, wherein deriving a plurality of training samples comprises processing input samples of the input data set to perform dimensionality reduction, thereby reducing a number of features in the training samples, preferably comprising performing principal component analysis.

27. A method according to any of the preceding claims, wherein deriving a plurality of training samples comprises scaling features of the training samples.

28. A method according to any one of the preceding claims, wherein the quantum computation environment is an emulation of a quantum processing unit having virtual qubits, and wherein emulating a quantum processing unit includes:
constructing, in the quantum computation environment, a Hamiltonian in the form of a matrix product operator for each input data vector from the input data set, the matrix product operator having dimension at least as large as the size of the data vector;
generating a random matrix product state;
iteratively determining a form of the matrix product state which is an eigenvector of the matrix product operator, having the lowest eigenvalue; and wherein
determining one or more properties of the ground state includes performing expectation value measurements on the matrix product state in the form of the matrix product state which is an eigenvector having the lowest eigenvalue.

29. A method comprising:
receiving a data sample comprising a data vector having a plurality of features;
processing the data vector using a quantum classification process including:
encoding the data vector on a set of real or virtual qubits of a quantum computation environment, the quantum computation environment being a quantum processing unit having real qubits or an emulation of a quantum processing unit having virtual qubits, to form a quantum system representing the data vector;
executing operations in the quantum computation environment to prepare the ground state of the quantum system;
determining one or more properties of the ground state; and
identifying one of a set of possible ground states corresponding to the data vector based on the one or more properties;
the method further comprising:
accessing a mapping that maps ground states to class labels;
associating a class label with the data sample based on the identified ground state and the mapping; and
outputting the class label as a classification of the further data sample.

30. A system having means, optionally comprising a computer device having a processor with associated memory and being coupled to a quantum computation environment, for performing a method according to any of the preceding claims.

31. A hybrid computer system for classifying data samples, comprising:
a quantum computation environment;
a controller adapted to implement operations in the quantum computation environment; and
a computer system configured to:
process a plurality of training samples to obtain a set of data vectors;
for each data vector, generate a quantum circuit adapted to:
represent the data vector on a quantum system of real or virtual qubits of the quantum computation environment;
prepare a ground state of the quantum system; and
measure one or more properties of the ground state;
transmit the quantum circuit to the controller for execution on the quantum computation environment;
receive measurement data representative of the one or more measured ground state properties from the controller; and
identify one of a set of possible ground states corresponding to the data vector based on the measurement data;
the computer system further configured to:
determine, based on the identified ground states and class labels associated with the training samples, a mapping that maps ground states to class labels; and
use the mapping to classify further data samples.

32. A system according to claim 31, configured to perform a method as set out in any of claims 1 to 29.

33. A computer program or computer readable medium comprising software code adapted, when executed by a data processing system connected to quantum computation environment, to configure the data processing system and associated quantum computation environment to perform a method as set out in any of claims 1 to 29.
